(19) United States
(12) Patent Application Publication
(10) Pub. No.: US 2022/0019872 A1
(43) Pub. Date: Jan. 20, 2022

(54) PROCESSOR, LOGIC CHIP AND METHOD FOR BINARIZED CONVOLUTION NEURAL NETWORK

(71) Applicant: UNITED MICROELECTRONICS CENTRE (HONG KONG) LIMITED, NEW TERRITORIES (HK)

(72) Inventors: Yuan LEI, NEW TERRITORIES (HK); Peng LUO, NEW TERRITORIES (HK)

(73) Assignee: UNITED MICROELECTRONICS CENTRE (HONG KONG) LIMITED, NEW TERRITORIES (HK)

(21) Appl. No.: 17/374,155

(22) Filed: Jul. 13, 2021

Related U.S. Application Data
(60) Provisional application No. 63/051,434, filed on Jul. 14, 2020.

(51) Int. Cl. G06N 3/04

(52) U.S. Cl. CPC G06N 3/04

(57) ABSTRACT

Examples of the present disclosure include a processor for implementing a binarized convolutional neural network (BCNN). The processor includes a shared logic module that is capable of performing both a binarized convolution operation and a down-sampling operation. The shared logic module is switchable between a convolution mode and a down-sampling mode by adjusting parameters of the shared logic module. In some examples the processor may be logic chip.

### CROSS-REFERENCE TO RELATED APPLICATIONS

This application claims priority to U.S. Ser. No. 63/051,434, entitled PROCESSOR, LOGIC CHIP AND METHOD FOR BINARIZED CONVOLUTION NEURAL NETWORK, filed Jul. 14, 2020, which is incorporated herein by reference

### BACKGROUND

This disclosure relates to neural networks. Neural networks are machine learning models that receive an input and process the input through one or more layers to generate an output, such as a classification or decision. The output of each layer of a neural network is used as the input of the next layer of the neural network. Layers between the input and the output layer of the neural network may be referred to as hidden layers.

Convolutional neural networks are neural networks that include one or more convolution layers which perform a convolution function. Convolutional neural networks are used in many fields, including but not limited to, image and video recognition, image and video classification, sound recognition and classification, facial recognition, medical data analysis, natural language processing, user preference prediction, time series forecasting and analysis etc.

Convolutional neural networks (CNN) with a large number of layers tend to have better performance, but place great demands upon memory and processing resources. CNNs are therefore typically implemented on computers or server clusters with powerful graphical processing units (GPUs) or tensor processing units (TPUs) and an abundance of system memory. However, with the increasing prevalence of machine learning and artificial intelligence applications, it is desirable to implement CNNs on resource constrained devices, such as smart phones, cameras and tablet computers etc.

### BRIEF DESCRIPTION OF THE DRAWINGS

Examples will now be described, by way of non-limiting example, with reference to the accompanying drawings, in which:

FIG. 1A shows an example convolutional neural network;

FIG. 1B shows an example of a convolution operation;

FIG. 1C shows an example max pooling operation;

FIG. 2 shows an example processor for implementing a convolutional neural network according to the present disclosure;

FIG. 3A shows an example logic chip for implementing a convolutional neural network according to the present disclosure;

FIG. 3B shows an example convolutional neural network according to the present disclosure;

FIG. 3C shows a conventional design of logic chip for implementing a convolutional neural network;

FIG. 3D shows an example logic chip for implementing a convolutional neural network according to the present disclosure;

FIG. 4 shows an example processor for implementing a convolutional neural network according to the present disclosure;

FIG. 5A shows an example method of implementing a convolution layer of a convolutional neural network according to the present disclosure;

FIG. 5B shows an example method of implementing a down-sampling layer of a convolutional neural network according to the present disclosure;

FIG. 6 shows an example of a binarized convolution operation according to the present disclosure;

FIG. 7 shows an example augmented binarized convolution module according to the present disclosure;

FIG. 8 shows an example augmented binarized convolution module according to the present disclosure;

FIG. 9 shows an example of operations performed by an augmented binarized convolution module according to the present disclosure when the module is in a convolution mode;

FIG. 10A shows an example of a binarized average pooling operation and a binarized max pooling operation;

FIG. 10B shows an example of operations performed by an augmented binarized convolution module according to the present disclosure when the module is in a down-sampling mode;

FIG. 10C shows another example of operations performed by an augmented binarized convolution module according to the present disclosure when the module is in a down-sampling mode;

FIG. 11 shows an example method of operation of an augmented binarized convolution module according to the present disclosure when the module is in a convolution mode;

FIG. 12 shows an example architecture of a convolutional neural network according to the present disclosure;

FIG. 13 shows an example method of designing a convolutional neural network according to the present disclosure; and

FIG. 14 shows an example method of classifying a feature map according to the present disclosure.

### SUMMARY

Accordingly, a first aspect of the present disclosure provides a processor for implementing a binarized convolutional neural network (BCNN) comprising a plurality of layers including a binarized convolutional layer and a down-sampling layer; wherein the binarized convolution layer and the down-sampling layer are both executable by a shared logical module of the processor, the shared logical module comprising: an augmentation unit to augment a feature map input to the shared logical module, based on an augmentation parameter; a binarized convolution unit to perform a binarized convolution operation on the feature map input to the shared logical module, based on a convolution parameter; and a combining unit to combine an output of the augmentation unit with an output of the binarized convolution unit; wherein the shared logic module is switchable between a convolution mode and a down-sampling mode by adjusting at least one of the augmentation parameter and the convolution parameter.

A second aspect of the present disclosure provides a logic chip for implementing a binarized convolutional neural network (BCNN), the logic chip comprising: a shared logic module that is capable of performing both a binarized convolution operation and a down-sampling operation on a feature map; a memory storing adjustable parameters of the shared logic module, wherein the adjustable parameters determine whether the shared logic module performs a binarized convolution operation or a down-sampling operation; and a controller or a control interface to control the shared logic module to perform at least one binarized convolution operation followed by at least one down-sampling operation by adjusting the adjustable parameters of the shared logic module.

A third aspect of the present disclosure provides a method of classifying an image by a processor implementing a binarized convolution neural network, the method comprising: a) receiving, by the processor, a first feature map corresponding to an image to be classified; b) receiving, by the processor, a first set of parameters including at least one filter, at least one stride and at least one augmentation variable; c) performing, by the processor, a binarized convolution operation on the input feature map using the at least one filter and at least one stride to produce a second feature map; d) performing, by the processor, an augmentation operation on the input feature map using the at least one augmentation variable to produce a third feature map; e) combining, by the processor, the second feature map and the third feature map; f) receiving a second set of parameters including at least one filter, at least one stride and at least one augmentation variable; and g) repeating c) to e) using the second set of parameters in place of the first set of parameters and the combined second and third feature maps in place of the first feature map.

Further features and aspects of the present disclosure are provided in the appended claims.

### DETAILED DESCRIPTION

For simplicity and illustrative purposes, the present disclosure is described by referring mainly to examples thereof. As used herein, the terms “includes” means includes but not limited to, the term “including” means including but not limited to. The term “comprises” means includes but not limited to, the term “comprising” means including but not limited to. The term “based on” means based at least in part on. The term “number” means any natural number equal to or greater than one. The terms “a” and “an” are intended to denote at least one of a particular element.

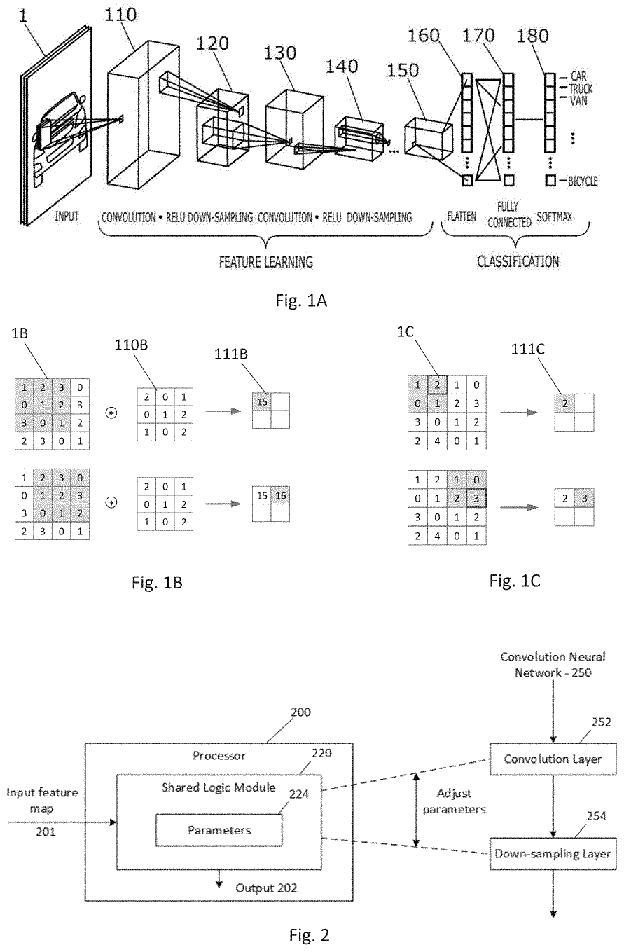

FIG. 1A shows an example of a convolutional neural network (CNN) 100 for classifying an image. A feature map 1 representing the image to be classified is input to the CNN. The CNN processes the input feature map 1 through a plurality of layers and outputs a classification 180, which in this example is one of a number of selected image classifications such as car, truck van etc.

In the example of FIG. 1A, the input feature map represents an image, but in other examples the input feature map may represent an audio signal, medical data, natural language text or other types of data. The feature map comprises values for each of a plurality of elements and in some examples may be expressed as a matrix. The CNN may have a plurality of output nodes. The output of the CNN may be a classification corresponding to one of the nodes (e.g. truck) or a probability for each of the predetermined output nodes (e.g. 95% car, 3% van, 2% truck). The output may, for example, be a classification or a decision based on the input feature map.

The layers of the CNN between the input 1 and the output 180 may not be visible to the user and are therefore referred to as hidden layers. Each layer of the CNN receives a feature map from the previous layer and processes the received feature map to produce a feature map which is output to the next layer. Thus a first feature map 1 is input to the CNN 100 and processed by the first layer 110 of the CNN to produce a second feature map which is input to the second layer 120 of the CNN, the second layer 120 processes the second feature map to produce a third feature map which is input to the third layer 130 of the CNN etc. A CNN typically includes a plurality of convolution layers, a plurality of down-sampling layers and one or more fully connected layers.

In the example of FIG. 1A, layers 110, 130 and 150 are convolution layers. A convolution layer is a layer which applies a convolution function to the input feature map. FIG. 1B shows an example of a convolution operation, in which an input feature map 1B is convolved with a filter (sometimes also referred to as a kernel) 110B. The convolution may comprise moving the filter over the input feature map and at each step calculating a dot product of the filter and the input feature map to produce a value for the output feature map 111B. Thus, in the example of FIG. 1B, the 3×3 filter 110B is multiplied with the shaded 3×3 area of the input feature map 1B and the result “15” forms the top left cell of the output feature map 111B. Then the filter is moved to the left as shown in the bottom part of FIG. 1B and another dot product taken, this time resulting in a value of “16” for the top right cell of the output feature map 111B. This process is continued until the filter has been moved over every cell of the input feature map and the output feature map is complete. Convolution makes it possible for a CNN to recognise features. As the CNN has many layers, earlier convolution layers may recognise basic features such as edges, while later layers may recognise more abstracted features such as shapes or constituent parts of an object.

In the example of FIG. 1A, layers 120 and 140 are down-sampling layers. A down-sampling layer is a layer which reduces the dimensions of the input feature map. Conventional neural networks perform down-sampling by average pooling or max pooling. In max pooling, shown in FIG. 1C, the values of the input feature map 1C are divided into sub-sets (e.g. subsets of 2×2 shaded in grey in FIG. 1C) and the maximum value of each subset forms a cell of the output feature map 111C. In average pooling the average value of each subset becomes the value of the corresponding cell of the output feature map. Down-sampling layers keep the number of nodes of the CNN within a manageable number by reducing the dimensions of the feature map passed to the next layer while retaining the most important information.

Conventional CNNs use a very large volume of memory to store the feature maps and weights (values) for the various convolution filters and use powerful processors to calculate the various convolutions. This makes it difficult to implement CNNs on resource constrained devices, which have limited memory and less powerful processors, especially where the CNN has many layers. Resource constrained devices may implement a CNN on a hardware logic chip, such as an Application Specific Integrated Circuit (ASIC) or Field Programmable Gate Array (FPGA), but this is challenging as such logic chips may have limited memory and processing power. Further, as the convolution layers and pooling layers carry out different logical operations, these layers require different logic components, which consumes a large area of silicon real-estate and increases the size and cost of the logic chip.

Accordingly, the present disclosure proposes a processor for implementing a binarized convolutional neural network (BCNN) comprising a plurality of layers including a binarized convolutional layer and a down-sampling layer, wherein the binarized convolution layer and the down-sampling layer are both executable by a shared logical module of the processor. By adjusting parameters of the shared logic module, the shared logic module is switchable between a convolution mode for performing convolution operations and a down-sampling mode for performing down-sampling operations. The shared logic module is called a shared logic module as it is capable of implementing both convolution layers and down-sampling layers of the CNN and is thus a shared logic resource for processing both types of layer. The shared logic module may also be referred to as an augmented binarized convolution module. Binarized as it performs binarized convolution and augmented as it is capable of down-sampling as well as convolution.

An example processor 200 according to the present disclosure is shown in FIG. 2. The processor 200 is configured to implement a CNN 250 including at least one convolution layer 252 and at least one down-sampling layer 254. The processor 200 comprises a shared logic module 220 which is configured to receive a feature map 201 input to the shared logic module, process the input feature map 201 according to parameters 224 of the shared logic module and output a feature map 202 based on the result of this processing. The type of processing carried out by the shared logic module 220 is governed by the parameters 224. By adjusting the parameters 224, the shared logic module 220 is switchable between a convolution mode and a down-sampling mode.

In the convolution mode the shared logic module 220 performs a binarized convolution on the input feature map 201 to implement a convolution layer 252 of the CNN and outputs 202 a convolved feature map. In the down-sampling mode the shared logic module 220 performs a down-sampling operation on the input feature map 201 to implement a down-sampling layer 254 of the CNN and outputs 202 a down-sampled feature map.

In some examples, the processor 200 may be a logic chip, such as a FPGA or ASIC. As the shared logic module 220 is capable of performing both convolution and down-sampling operations, the size and/or cost of the logic chip may be reduced compared to a conventional CNN logic chip which has separate convolution and down-sampling modules. Furthermore, as the convolution layer 252 is implemented by the shared logic module 220 performing a binarized convolution, the processing and memory demands are significantly reduced compared to a conventional CNN.

In other examples, the shared logic unit 220 may be implemented by machine readable instructions executable by the processor 200. For example, the CNN may be implemented on a desktop computer, server or cloud computing service etc., while the CNN is being trained and the weights adjusted ('the training phase') and then deployed on a logic chip for use in the field ‘the inference phase’, once the CNN has been trained and the convolution weights finalized.

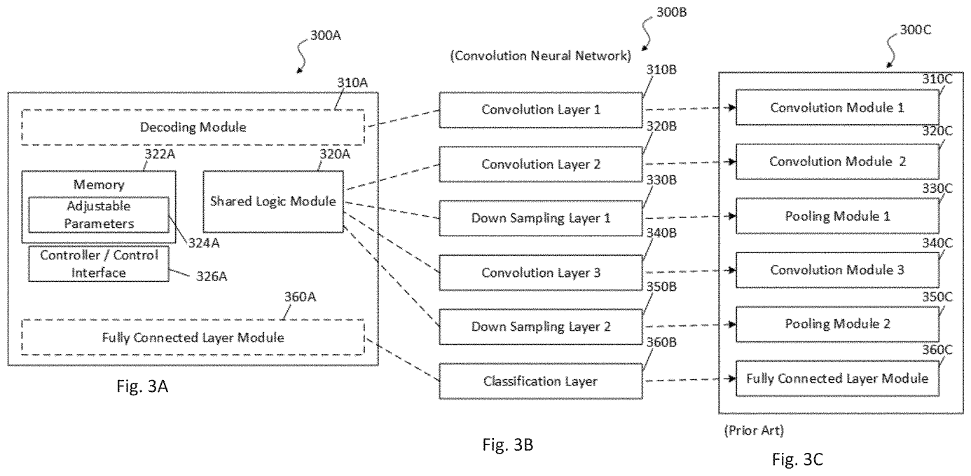

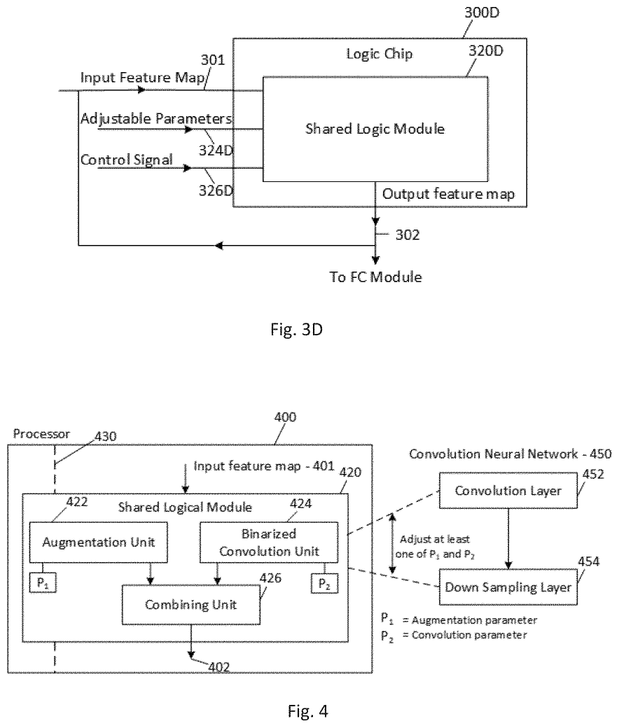

FIGS. 3A, 3B and 3C are schematic diagrams which illustrate how a hardware logic chip, such as a FPGA or ASIC, according to the present disclosure may use fewer hardware components and/or use less silicon real-estate compared to prior art logic chips. FIG. 3B shows an example CNN 300B which includes the following sequence of layers: a first convolution layer 310B, a second convolution layer 320B, a first down-sampling layer 330B, a third convolution layer 340B, a second down-sampling layer 350B and a classification layer 360B. The layers may for example perform the same functions as the convolutional, down-sampling and classification layers shown in FIG. 1A. FIG. 3A shows an example of a logic chip 300A according to the present disclosure which is capable of implementing the CNN 300B of FIG. 3B. Meanwhile, FIG. 3C shows a conventional design of logic chip 300C, which uses prior art techniques to implement the CNN 300B of FIG. 3B.

It can be seen that the conventional logic chip 300C, has a separate hardware module for each layer of the CNN 300B. Thus, the logic chip 300C has six modules in total: a first convolution module 310C, a second convolution module 320C, a first pooling module 330C, a third convolution module 340C, a second pooling module 350C and a classification layer 360C. Each module implements a corresponding layer of the CNN as shown by the dotted arrows, for example the first convolution layer 310B is implemented by the first convolution module 310C, the first down-sampling layer 330B is implemented by the first pooling module 330C etc.

In contrast, the logic chip 300A is capable of implementing the CNN 300B with a smaller number of hardware modules compared to the conventional design of logic chip 300C. This is because the logic chip 300A includes a shared logic module (which may also be referred to as an augmented binarized convolution module) 320A, which is capable of implementing both convolution and down-sampling layers. Thus, as shown by the dotted lines, the augmented binarized convolution module 320A of the logic chip 300A implements the layers 320B, 330B, 340B and 350B of the CNN 300B. In other words, a single module 320A performs functions which are performed by a plurality of modules in the conventional logic chip of 300C. Thus the logic chip 300A may have a smaller chip size and reduced manufacturing costs compared to the logic chip 300C.

In FIG. 3A, the logic chip 300A comprises a shared logic module 320A, a memory 322A and a controller 326A. While the memory 322A and controller 326A are shown as separate components in FIG. 3A, in other examples the memory and/or controller may be integrated with and form part of the shared logic module 320A. The shared logic module 320A is capable of performing both a binarized convolution operation and a down-sampling operation on a feature map input to the module 320A. The memory 322A stores adjustable parameters 324A which determine whether the shared logic module 320A performs a binarized convolution operation or a down-sampling operation on the feature map. The controller 326A is configured to control the shared logic module 320A to perform at least one binarized convolution operation followed by at least one down-sampling operation by adjusting the adjustable parameters 324A of the shared logic module.

In one example, the controller 326A may store a suitable set of adjustable parameters and send a control signal to cause the shared logic module to read a feature map and perform an operation on the feature map based on the adjustable parameters. The controller 326A may for instance be a processing component which controls operation of the logic chip. In other examples the controller 326A may be a control interface which receives control signals from a device external to the logic chip 300A, wherein the control signals set the adjustable parameters and/or control the shared logic module 320A.

The logic chip 300A may also include a decoding module 310A for receiving a non-binarized input, converting the input into a binarized feature map and outputting a binarized feature map to the shared logic module. In this context, decoding means converting a non-binarized feature map into a binarized feature map. For example the decoding module 310A may be a convolution module which receives a feature map input to the logic chip and performs a convolution operation followed by a binarization operation to output a binarized feature map to the module 320A. In another example, instead of using convolution, the decoding module may convert 8-bit RGB data to thermometer code in order to convert a non-binarized input into a binarized feature map. The input data received by the logic chip may, for example, be an image, such as an image generated by a camera, a sound file or other types of data. In other examples the logic chip 300A may not include a decoding module, but may receive a binarized feature map from an external decoding module. In such other examples, the decoding may be implemented on a separate logic chip.

The logic chip 300A may also include a fully connected layer module 360A for classifying the feature map output from the shared logic module 320A. The fully connected layer module 360A thus implements the classification layer 360B of the CNN 300B. In other examples the logic chip 300A may not include a fully connected layer module, but may output a feature map to an external fully connected layer module. In such other examples, the classification layer may be implemented on a separate logic chip.

In the example of FIG. 3A, the logic chip 300A includes a shared logic module 320A, a memory 322A and a controller 326A. FIG. 3D is an example of a logic chip 300D in which the memory and the controller are provided externally and do not form part of the logic chip. The logic chip 300D comprises a shared logic module 320D which has at least one input interface to receive an input feature map 301, adjustable parameters 324D and a control signal 326D and an output interface to output an output feature map 302. For example, the input feature map 301 and the adjustable parameters may be read from an external memory. The input feature map 301 may, for example, be a feature map output from an external decoding module or a feature map output by the shared logic module in a previous processing cycle when implementing a previous layer of the CNN. In some examples, the input feature map may be based on an image captured by a camera or data captured by a physical sensor. After implementing the final down-sampling or convolution layer of the CNN (e.g. layer 350B in FIG. 3B), the shared logic module 320D may output a resulting feature map to another logic chip for implementing a fully connected layer of the CNN.

As explained above, in some examples by using shared logic module 320A, 320D the logic chips 300A, 300D may save space and use fewer hardware modules compared to conventional designs. Further, as the shared logic module 320A, 320D performs a binarized convolution the memory used and processing power required may be reduced compared a conventional logic chip which performs non-binarized convolution. Further, as the shared logic module 320A, 320D performs down-sampling, the information loss which often occurs when performing average or max pooling on binarized feature maps may be reduced or avoided.

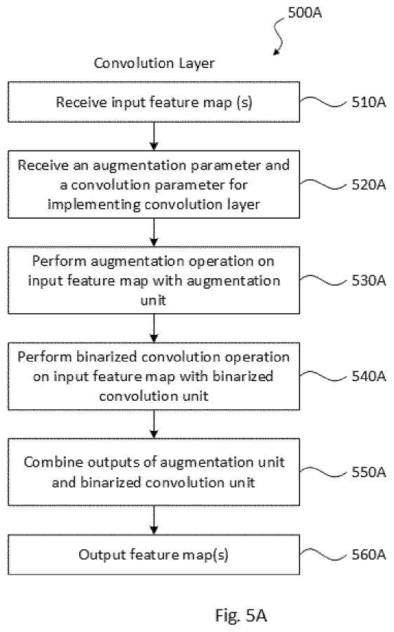

FIG. 4 shows a further example of a processor 400 for implementing a convolutional neural network according to the present disclosure. The processor 400 includes a shared logic module 420 which is to implement both a convolution layer 452 and a down-sampling layer 454 of the CNN 450. This may be done by adjusting parameters P1, P2 of the shared logic module 420. The processor 400, shared logic module 420, CNN 450 and layers 452 and 454 may correspond to the processor 200, shared logic module 220, CNN 250 and layers 252 and 254 in the example of FIG. 2.

The shared logical module 420 may comprise an augmentation unit 422, a binarized convolution unit 424 and a combining unit 426. The augmentation unit 422 may be configured to augment a feature map input to the shared logical module, based on at least one augmentation parameter P1. The binarized convolution unit 424 may be configured to perform a binarized convolution operation on the feature map 401 input to the shared logical module, based on at least one convolution parameter P2. The combining unit 426 may be configured to combine an output of the augmentation unit 422 with an output of the binarized convolution unit 424. The shared logic module 420 is switchable between a convolution mode and a down-sampling mode by adjusting at least one of the augmentation parameter P1 and the convolution parameter P2.

In some examples the processor 400 may contain only the shared logic module 420, while in other examples, the processor 400 may include further modules indicated by the dotted lines 430. For instance, such further modules may include a decoding module and a fully connected layer module etc.

As with the example of FIG. 2, because the shared logic module 420 of FIG. 4 is able to perform both convolution and down-sampling, the number of logical components needed to implement the CNN on a hardware logic chip is reduced. As the shared logic unit has a binarized convolution unit, the convolution layers may be implemented with less memory and processing power compared to non-binarized approaches. Furthermore, as the down-sampling is handled by the binarized convolution unit and/or augmentation unit, rather than by average pooling or max pooling, this avoids or reduces the information loss that occurs when average pooling or max pooling is applied to a binarized feature map.

The augmentation unit may help to avoid information loss in the convolution layers as well. One difficultly with binarized CNNs is that information is lost, especially in the deeper layers of the network after several binarized convolutions, which can impede the training process and ability of the CNN to recognize patterns. In the architecture of FIG. 4, at each layer, the input feature map 401 is provided to both the augmentation unit 422 and the binarized convolution unit 424 and the output of the augmentation unit 422 is combined with the output of the binarized convolution unit 424. This helps to avoid or reduce excessive information loss, as the augmentation operation by the augmentation unit may retain some or all of the original data of the input feature map and pass such information to the next layer.

In one example, the combining unit is configured to concatenate the output of the augmentation unit with the output of the binarized convolution unit.

The augmentation unit 422 is configured to augment the input feature map 401 by performing at least one augmentation operation. An augmentation operation is an operation which generates a new feature map based on the input feature map while retaining certain characteristics of the input feature map. The augmentation operation may for example include one or more of: an identity function, a scaling function, a mirror function, a flip function, a rotation function, a channel selection function and a cropping function. An identity function copies the input so that the feature map output from the augmentation unit is the same as the feature map input to the augmentation unit. A scaling function multiplies the value of each cell of the input feature map by the same multiplier. For example the values may be doubled if the scaling factor is 2 or halved if the scaling factor is 0.5. If the scaling factor is 0, then a null output is produced. A null output is no output or an output feature map in which every value is 0. Mirror, flip and rotation functions reflect a feature map, flip a feature map about an axis or rotate the feature map. A channel selection function selects certain cells from the feature map and discards others, for instance selecting randomly selected rows or all even rows or columns, while discarding odd rows or columns etc. A cropping function removes certain cells to reduce the dimensions of the feature map, for example removing cells around the edges of the feature map.

In one example, the augmentation unit 422 is configured to perform a scaling function on the feature map and the augmentation parameter P1 is a scaling factor. In one example, the scaling factor is set as a non-zero value in the convolution mode and the scaling factor is set as a zero value in the down-sampling mode. In this way the output of the augmentation unit is a null value and may be discarded in the down-sampling mode. In a hardware implementation, in operation modes where the scaling factor is zero, the augmentation operation may be skipped in order to save energy and processing power. Where the combination is by concatenation, a null value from the augmentation unit may reduce the number of output channels, thus enabling reduction of the number of output channels, as well as the feature map dimensions, which may be desirable for a down-sampling layer in some CNN architectures.

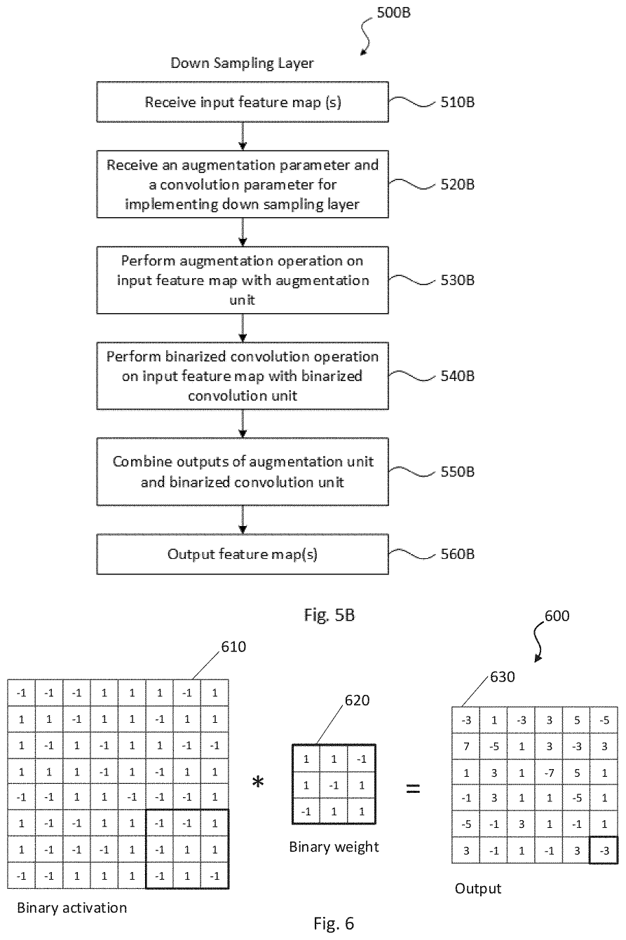

FIG. 5A shows an example method 500A of implementing a convolutional layer of a binarized convolutional neural network (BCNN) with a shared logic module of a processor according to the present disclosure. For example, the method may be implemented by the shared logic module 420 of the processor 400 of FIG. 4, when the shared logic module 420 is in the convolution mode.

At block 510A an input feature map is received by the shared logic module. The input feature map may for example be a feature map input to the BCNN or a feature map received from a previous layer of the BCNN.

At block 520A, an augmentation parameter and a convolution parameter for performing the convolutional layer are received by the shared logic module. For example, the shared logic module may read these parameters from memory or receive the parameters through a control instruction.

At block 530A an augmentation operation is performed on an input feature map by the augmentation unit.

At block 540A, a binarized convolution operation is performed on the input feature map by the binarized convolution unit.

At block 550A, the outputs of the binarized convolution unit and the augmentation unit are combined.

At block 560A, one or more feature maps are output based on the combining in block 550.

For example, the feature maps output by the augmentation unit and the binarized convolution unit may be concatenated in block 550A and the concatenated feature maps may then be output in block 560A.

FIG. 5B shows an example method 500B of implementing a down-sampling layer of a BCNN with a shared logic module of a processor according to the present disclosure. For example, the method may be implemented by the shared logic module 420 of the processor 400 of FIG. 4, when the shared logic module 420 is in the down-sampling mode.

At block 510B an input feature map is received by the shared logic module. The input feature map may for example be a feature map input to the BCNN or a feature map received from a previous layer of the BCNN.

At block 520B, an augmentation parameter and a convolution parameter for performing the convolutional layer are received by the shared logic module. For example, the shared logic module may read these parameters from memory or the parameters may be received through a control instruction.

At block 530B an augmentation operation is performed on an input feature map by the augmentation unit.

At block 540B, a binarized convolution operation is performed on the input feature map with the binarized convolution unit.

At block 550B, the outputs of the binarized convolution unit and the augmentation unit are combined.

At block 560B, one or more feature maps are output based on the combining in block 550.

For example, if the feature maps output by the augmentation unit and the binarized convolution unit may be concatenated in block 550B and the concatenated feature maps may then be output in block 560B.

It will be appreciated that the processing blocks of the shared logic module are the same in the convolution and down-sampling modes, but differ in the parameters are used. Thus by adjusting the parameters the augmented binarized convolution module can be switched between a convolution mode and a down-sampling mode. It will also be appreciated from the above that in the examples of FIGS. 4, 5 and 6, there are two principle operations involved—binarized convolution and augmentation. Examples of augmentation operations have been described above. An example of a binarized convolution will now be described, by way of non-limiting example, with reference to FIG. 6.

As can be seen from FIG. 6, the operation of a binarized convolution 600 is similar to the operation of the normal (non-binarized) convolution shown in FIG. 1B. That is, a filter 620 is moved over the input feature map 610 and dot products of the overlying elements are calculated for each step. At each step the filter moves across, or down, the input feature map by a number of cells equal to the stride. The sum of the values at each step form the values of cells of the output feature map 630. However, unlike a normal convolution in which the cells may have many different values, in a binarized convolution the values of the input feature map 610 and the values of the filter 620 are binarized. That is the values are limited to one of two possible values, e.g. 1 and 0. This significantly reduces the memory required to perform the convolution, as only 1 bit is needed to hold the value of each cell of the input feature map and each cell of the filter. Further, the dot product calculation is significantly simplified, as the multiplied values are either 1 or 0 and therefore the dot product can be calculated using a XNOR logic gate. Thus the processing power and complexity of logic circuitry for binarized convolution is significantly reduced compared to normal (non-binary) convolution, as normal convolution may involve floating point operations and typically uses a more powerful processor, or more complicated arrangements of logic gates.

In one example, the parameters used by the shared logic module or augmented binarized convolution module include a filter and a stride. A filter may be a matrix which is moved across the feature map to perform a convolution and the stride is a number of cells which the filter is moved in each step of the convolution.

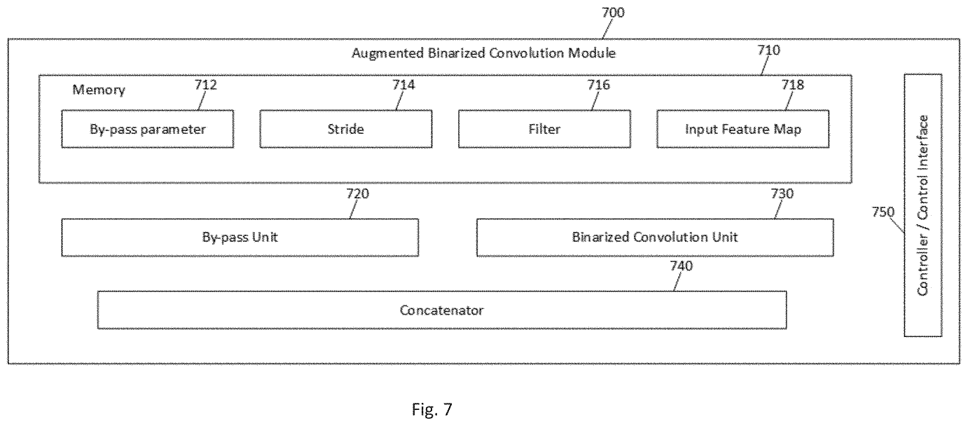

FIG. 7 is a schematic example of an augmented binarized convolution module 700 according to the present disclosure. It may for example be used as the shared logic module in FIG. 2, 3A, 3D or FIG. 4 and may implement the methods of FIG. 5A and FIG. 5B.

The augmented binarized convolution module 700 may comprise a memory 710 and a controller or control interface 750. The memory 710 may store an input feature map 718 which is to be processed in accordance with a plurality of parameters including a by-pass parameter 712, a stride 714 and a filter 716. The by-pass parameter 712 may correspond to the augmentation parameter P1 in FIG. 4, while the stride and filter may correspond to the convolution parameter P2 in FIG. 4. While just one stride, filter, augmentation parameter and feature map are shown in FIG. 4, it is to be understood that multiple strides, filters, augmentation parameters and or feature maps may be stored in the memory 710.

The augmented binarized convolution module 700 comprises an augmented binarized convolution unit 730, a bypass unit 720, a concatenator 740. The augmented convolution module may receive an input feature map 718 and may store the input feature map 718 in memory. The input feature map 718 may, for example, be received from a previous processing cycle of the augmented binarized convolution module 700 or from another logical module, such as a decoding module.

The binarized convolutional unit 730 is configured to perform a binarized convolution operation on the input feature map. The unit 730 may correspond to the binarized convolution unit 424 in FIG. 4. The binarized convolutional unit may include logic gates, such as XNOR gates, for performing binarized convolution. The binarized convolution unit may multiply values of the input feature map 718 with values of the filter 716 as the filter is moved in steps equal to the stride over the input feature map. The binarized convolutional unit 730 may output the result of the binarized convolution to the concatenator 740.

The by-pass unit 720 is configured to forward the input feature map to the concatenator 740. The by-pass unit 720 is referred to as a by-pass unit as it by-passes the binarized convolution. In some examples the by-pass unit may be configured to perform an augmentation operation on the input feature map before forwarding the input feature map to the concatenator. Thus the by-pass unit may act in a similar manner to the augmentation unit 422 of FIG. 4.

The concatenator 740 is configured to concatenate the output of the binarized convolution unit with the output of the by-pass unit. The concatenator may correspond to the combining unit 426 of FIG. 4.

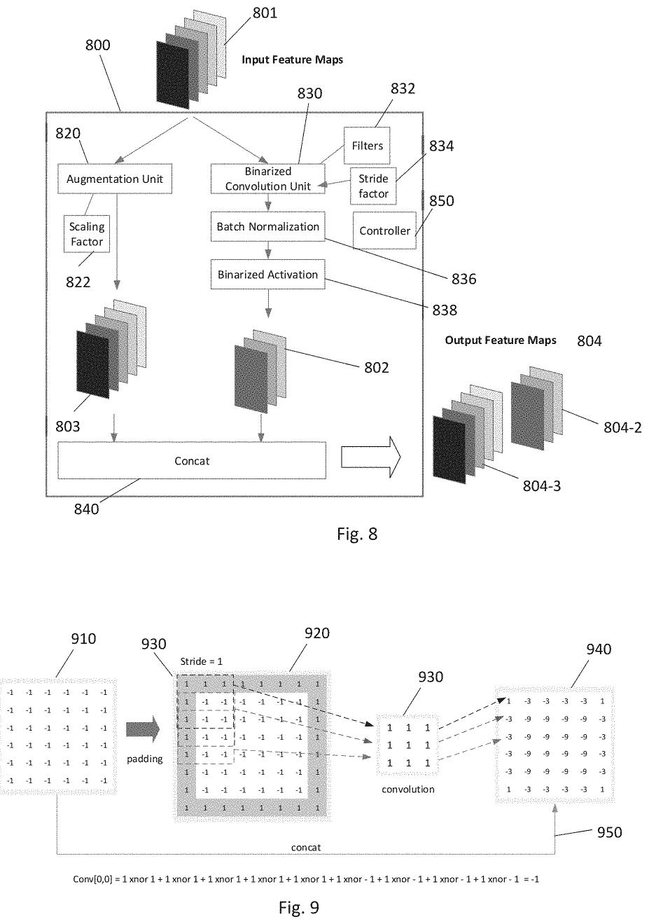

FIG. 8 is a schematic diagram showing an example of an augmented binarized convolution module 800, together with feature maps 801 input to the module and feature maps 804 output from the module. FIG. 8 is an example of a specific implementation and the present disclosure is not limited to the specific arrangement of features in FIG. 8, but rather FIG. 8 is one possible implementation of the augmented binarized convolution modules and shared logic modules described in FIGS. 2-7 above.

The augmented binarized convolution module 800 comprises an augmentation unit 820, a binarized convolution unit 830 and a concatenator 840. These units may operate in the same way as the augmentation or by-pass modules, binarized convolution module and concatenators described above in the previous examples. The augmented binarized convolution module 800 further comprises a controller 850 and one or more memories storing parameters including a scaling factor 822 for use by the augmentation module and filters 832 and strides 834 for use by the binarized convolution unit. The controller 850 controls the sequence of operations of the module 800. For example, the controller may set the scaling factor 822, filters 832 and stride 834, may cause the input feature maps 801 to be input to the augmentation unit 820 and the binarized convolution unit 830 and may instruct the augmentation unit 820 and binarized convolution unit 830 to perform augmentation and convolution operations on the input feature maps.

There may be a plurality of input feature maps 801 as shown in FIG. 8, which may be referred to as first feature maps. Each feature map comprises a plurality of values, also known as activations. The feature maps are binarized, for example each value is either 1 or 0. Each input feature map may be referred to as an input channel of the current layer, so if there are 5 input feature maps of size 32×32, then it can be said the current layer has 5 input channels with dimensions of 32×32. The first feature maps 801 are input to both the augmentation unit 820 and the binarized convolution unit 830.

The binarized convolution unit 830 may perform binarized convolutions on each of the first feature maps 801 using the filters 832 and the strides 834, for instance as described above with reference to FIG. 6. The binarized convolution unit may perform a n×n binarized convolution operation, which is a binarized convolution operation using a filter having dimensions of n×n (e.g. 3×3 in the example of FIG. 6). In some examples, the n×n binarized convolution operation may followed by a batch normalization operation 836 and/or a binarized activation operation 838.

The batch normalization operation 836 is a process to standardize the values of the output feature map resulting from the binarized convolution. Various types of batch normalization are known in the art. One possible method of batch normalization comprises calculating a mean and standard deviation of the values in the feature map output from the binarized convolution and using these statistics to perform the standardization. Batch normalization may help to reduce internal covariate shift, stabilize the learning process and reduce the time taken to train the CNN.

The binarized activation operation 838 is an operation that binarizes the values of a feature map. Binarized activation may for example be applied to the feature map resulting from the batch normalization operation 836, or applied directly on the output of the binarized convolution 830 if there is no batch normalisation. It can be seen in FIG. 6 that the activation values of the feature map output from the binarized convolution are not binarized and may be larger than 1. Accordingly, the binarized activation binarizes these values to output a binarized feature map 802 as shown in FIG. 8.

In some examples, the n×n binarized convolution operation, batch normalization and binarized activation operation may be compressed into a single computational block by merging parameters of the batch normalization with parameters of the n×n binarized convolution operation and the binarized activation operation. For example, they may be compressed into a single computational block in the inference phase, in order to reduce the complexity of the hardware used to implement the CNN once the CNN has been trained. For example, in order to reduce units 830, 836 and 838 to a single computational block, the batch normalization operation 836 may replaced with a sign function and the parameters of the batch normalization (γ, β), running mean and running variance may be absorbed by the activation values of the filters 832 of the binarized convolution.

Thus the binarized convolution unit 830 performs a convolution on the input feature maps 801 and outputs a set of feature maps 802 which may be referred to as the second feature maps. Meanwhile the augmentation unit 820 performs an augmentation operation on the input feature maps 801. For example the augmentation operation may be a scaling operation carried out in accordance with the scaling factor 822. The augmentation unit outputs a set of feature maps 803 which may be referred to as the third feature maps.

The concatenator 840 concatenates the second feature maps 802 with the third feature maps 803. This results in a set of output feature maps 804 which comprises the second feature maps 804-2 and the third feature maps 804-3. The second feature maps and third feature maps may be concatenated in any order. For example, the third feature maps may be placed in front followed by the second feature maps behind, as shown in FIG. 8, or vice versa.

While the example of FIG. 8 shows a concatenation in which all of the feature maps 804-3 output by the augmentation unit are kept together and all of the feature maps 804-2 output by the binarized convolution unit are kept together, the concatenation according to the present disclosure is not limited to this. The outputs of the binarized convolution unit and the augmentation unit may be concatenated on a channel by channel basis (i.e. feature map by feature map basis), rather than keeping the channels of each unit together. So for example, the concatenator may output a first output channel of the augmentation unit, followed by a first output channel of the binarized convolution unit, followed by a second output channel of the augmentation unit etc. The individual output channels of the augmentation unit and the binarized convolution unit may be concatenated in any order or combination, like shuffling a deck of cards. The order in which the channels are combined may for example be determined randomly or in accordance with a predetermined scheme.

FIG. 9 shows an example of the process when the augmented binarized convolution module 800 is in a convolution mode for implementing a convolution layer of the CNN. Convolution parameters are set including a filter 930 and a stride which in this example is set to 1. The augmentation operation in this example is a scaling operation with the scaling factor set to 1, so that the augmentation operation duplicates the input feature map 910.

To facilitate the convolution operation the input feature map 910 may be padded. Padding involves adding extra cells around the outside of the input feature map 910 to increase the dimensions of the feature map. For example, in FIG. 9, the input feature map 910 has dimensions of 6×6 and after padding, by adding cells of value 1 around the outside, the padded input feature map 920 has dimensions 7×7. In other examples the padding could add cells with a value of 0. Padding increases the area over which the filter 930 can move over the feature map and may allow more accurate feature classification or extraction.

The padded input feature map 920 is then convolved with the filter 930. As both the feature map 920 and the filter 930 are binarized, the convolution is a binarized convolution. In each step of the convolution the filter 930 is moved over feature map 920 by a number of cells equal to the stride which, in the example of FIG. 9, is set to 1. The dotted lines in FIG. 9 show three steps of the convolution as the filter is moved over the feature map 920. In each step of the convolution the values of each cell of the filter are multiplied by the corresponding values of each cell of the feature map and the results are summed to give the value of a cell of the output feature map 940. Thus each step in the convolution provides the value of a single cell of the output feature map 940. The input feature map 910 may correspond to the first feature map 801 of FIG. 8 and the output feature map 940 may correspond to the second feature map 802 of FIG. 8. Due to the padding, the filter 930 can move in 6 steps over the feature map 920, so in this example, the output feature map 940 has dimensions of 6×6, which is the same as the dimensions of the input feature map 910.

In the example of FIG. 9, the scaling factor is set to 1, so the input feature map 910 is duplicated (e.g. this duplicated feature map corresponds to the third feature map 803 in FIG. 8). The duplicated input feature map 910 is concatenated 950 with the output feature map 940. The concatenated feature maps 910, 940 correspond to the output feature maps 804 in FIG. 8.

Thus it will be appreciated that in some examples, in the convolution mode, the binarized convolution unit is configured to output a feature map having dimensions which are the same as dimensions of a feature map input to the binarized convolution unit. This may, be achieved by selecting appropriate dimensions of filter, an appropriate stride and/or padding of the input feature map. In other examples, the architecture of the CNN may include a convolution layer which outputs feature maps of smaller dimensions than are input to the convolution layer, in which case when implementing such layers, the binarized convolution unit may be configured to output a feature map having dimensions which are smaller than the dimensions of a feature map input to the binarized convolution unit

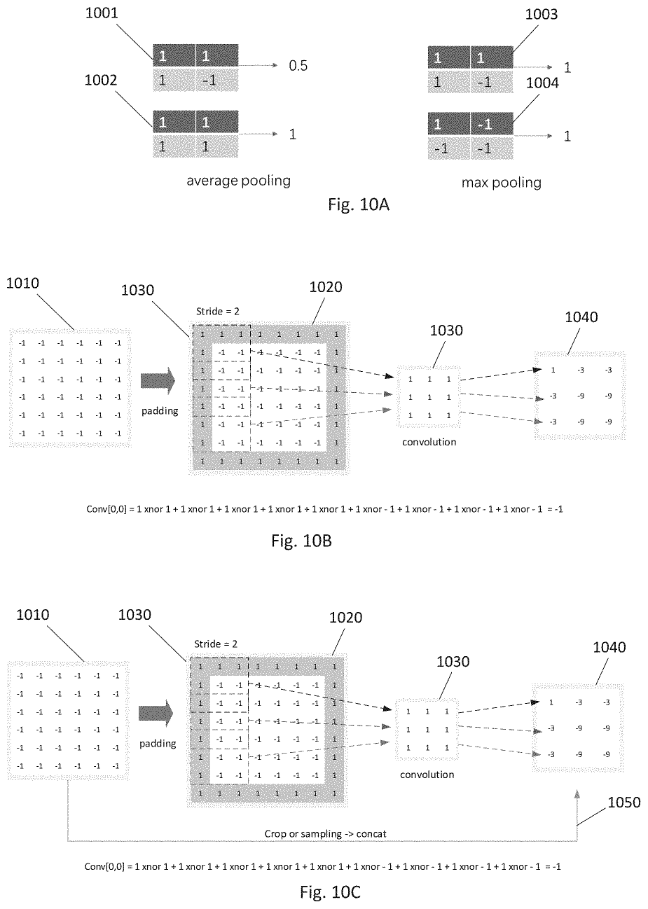

In the down-sampling mode, the augmented binarized convolution module performs a down-sampling operation which reduces the dimensions of the input feature map. Conventional CNNs use max pooling or average pooling to perform down-sampling. However, as shown in FIG. 10A, average pooling and max pooling may result in information loss when the input feature map is binarized. For example, feature maps 1001 and 1002 in FIG. 10A are different, but when average pooling for 2×2 cells is applied this gives output values of 0.5 and 1 and if the value of 0.5 is rounded up to the nearest binarized value, then the outputs will be the same. Meanwhile, feature maps 1003 and 1004 are very different, but when max pooling is applied the output value for both is 1.

Examples of the present disclosure avoid or reduce this information loss by instead using a binarized convolution for at least part of the down-sampling operation. FIG. 10B shows an example in which an input feature map 1010 is padded and the padded feature map 1020 is convolved with a filter 1030 to produce an output feature map 1040, similar to the process shown in FIG. 9. The filter may be set to a filter for down-sampling which may be the same, or different to, filters for binarized convolution. The stride may be set to a value appropriate for down-sampling. In some examples the stride is set to an integer value equal to or greater than 2. In general the greater the stride, the smaller the dimensions of the output feature map 1040.

Thus, when performing a down-sampling operation the binarized convolution unit may be configured to output a feature map having dimensions which are smaller than dimensions of the feature map input to the binarized convolution unit. The size of the output feature map depends upon whether padding is carried out, the dimensions of the filter and the size of the stride. Thus by selecting appropriate filters and strides the binarized convolution unit may be configured to output a feature map having smaller dimensions than the input feature map.

In the example of FIG. 10B, the augmentation operation is a scaling operation but the scaling factor is set to zero. This causes the augmentation unit (which may also be referred to as a by-pass unit) to provide a null output. This reduces the number of output channels as in this case the output comprises the feature maps 1040 output from the binarized convolution unit and there are no feature maps output from the augmentation unit. Thus with reference to FIG. 8, in cases where the augmentation unit outputs a null output, the feature maps 804 output from the augmented binarized convolution module would comprise the second feature maps 804-2 only.

Thus it will be appreciated that, in some examples, the augmentation unit is configured to output a null output to the concatenator when the augmented binarized convolution module performs a down-sampling operation. This may help to reduce the number of output channels output from the down-sampling layer.

While FIG. 10B, shows an example in which the augmentation unit outputs a null value in the down-sampling mode, FIG. 10C shows an example in which augmentation unit outputs an actual (i.e. not a null) value in the down-sampling mode. The operation of the binarized convolution unit in FIG. 10C is the same as in FIG. 10B and like reference numerals indicate like features—i.e. the input feature map 1010 is padded 1020 and convolved with a filter 1030 to generate an output feature map 1040. The output feature map 1040 may, for example, correspond to the output feature map 802 in FIG. 8. However, unlike in FIG. 10B, in FIG. 10C, the output of the augmentation unit is concatenated 1050 with the output feature map 1040.

The augmentation unit may perform any augmentation operation. However, for illustrative purposes, in the example of FIG. 10C the augmentation unit performs an identity operation similar to that in FIG. 9. One way to look at this is that in FIG. 10B, the augmentation unit performs a scaling operation with scaling factor 0 (which outputs a null output), while in FIG. 10C, the augmentation unit performs as scaling operation with scaling factor 1 (which is an identity operation). In some other examples, the scaling factor may have other non-zero values in the down-sampling mode. For instance, in some examples, the scaling factor in the down-sampling mode may be greater than zero but less than 1.

The augmentation unit (which may also be referred to as the by-pass unit) may perform a cropping or sampling operation to reduce a size of a feature map input to the augmentation unit before forwarding the feature map to the concatenator. In this way, when a down-sampling operation is being performed and the output of the augmentation unit is not null, the augmented feature map may be cropped to the same size as the feature map 1040 which is output from the binarized convolution unit. For example, in FIG. 10C, the augmentation unit copies the input feature map 1010 which has dimensions 6×6, but crops the feature map to 3×3 so that it has the same size as the feature map 1040 output from the binarized convolution unit. In this way the feature maps output from the augmentation unit and the binarized convolution unit have the same size and can be concatenated.

It will be appreciated that the examples of FIGS. 6, 9, 10B and 10C show only one input feature map, while the example of FIG. 8 shows a plurality of input feature maps 801. In practice, in many cases a plurality of feature maps (also referred to as input channels) will be input to the augmented binarized convolution module or shared logic module. For example, the input to the CNN may comprise RGB values for a two dimensional image which could be represented by three input feature maps (i.e. three input channels, one feature map for each of the red, green and blue values). In some cases the CNN may include a decoding module which may output a plurality of feature maps to the augmented binarized convolution module. Further, the output of the shared logic or augmented binarized convolution module when implementing a convolution of down-sampling layer of the CNN may comprise a plurality of output feature maps (output channels) which may be input back into the shared logic or augmented binarized convolution module for implementing the next layer of the CNN.

Thus, while FIGS. 6, 9, 10B and 10C show a single input feature map and a filter having two dimensions, it is to be understood that when there are multiple input feature maps, the filter may have a depth equal to the number of input feature maps and the filter may be applied to all of the input feature maps at once. For example, if there are five input channels, the filter may have a depth of five layers with each layer of the filter having the same values (also referred to as activations or activation values). The filter thus overlaps with a slice of the input channels extending from the first to last input channel and the sum of the dot products are taken to provide the activation for the output channel. At each step in the convolution, the dot products of each input channel with the filter may be summed to produce a single cell of the output channel. Thus it will be appreciated that regardless the number of input channels (input feature maps), each filter in the binarized convolution unit generates a single output channel (output feature map). Therefore the number of output channels from the binarized convolution unit is equal to the number of filters.

The number of output channels from the augmentation unit depends on the number of augmentation operations performed. The number of augmentation operations may be controlled by an augmentation parameter and/or a control signal from the controller or control interface. In some examples, in the convolution mode, the augmentation unit is configured to generate a number of output channels equal to the number of output channels of the binarized convolution unit. For example, if the binarized convolution unit has ten output channels then the augmentation unit may have ten output channels and the augmented binarized convolution module or shared logic module will have a total of twenty output channels.

In some examples, in the down-sampling mode, the shared logic module (e.g. augmented binarized convolution module) is configured to output a number of channels that is less than a number of channels that are input to the shared logic module. In this way the down-sampling layer may not only reduce the dimensions of the input feature maps, but also reduce the number of output channels. This may help to prevent the CNN becoming too large or complex. One way in which the number of output channels may be reduced is for the augmentation unit to have a null output, e.g. due to a scaling factor of zero.

Therefore, in some examples, in the down-sampling mode the augmentation unit is configured to provide a null output so that the output of the shared logic module in the down-sampling mode comprises the output of the binarized convolution unit only.

In CNNs, binarization can sometimes lead to data loss causing the activations in deeper layers to trend to zero. In some examples of the present disclosure, in the convolution mode, information from feature maps of previous layers may be provided to subsequent layers of the CNN by concatenating the output of the augmentation unit with the output of the augmentation unit. This may help to prevent or reduce such information loss. In some examples the augmentation operation is an identity operation. In other examples, the augmentation operation may introduce minor modifications to the input feature map (e.g. by scaling, rotating, flip or mirror operations etc), which may help to strengthen invariance of the CNN to minor variations in the input data.

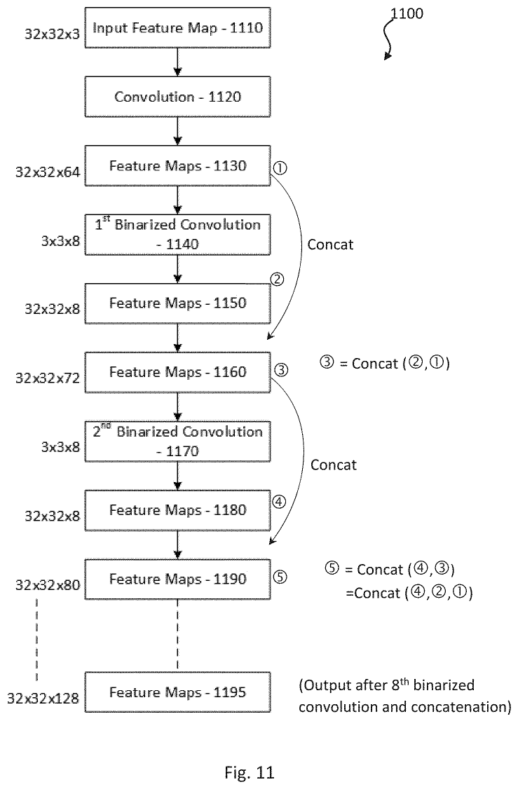

FIG. 11 shows an example 1100 which illustrates how the concatenation enables information to be retained and propagated through one or more layers of the CNN.

At block 1110 a set of feature maps is input to the CNN. In this example, the input feature maps comprise three channels of dimensions 32×32, which is expressed as 32×32×3 in FIG. 11.

At block 1120 a convolution is performed which produces 64 output channels of dimensions 32×32. The convolution may, for example, be performed by a decoding module.

At block 1130, the feature maps output by the convolution 1120 may be binarized. The feature maps may be expressed as 32×32×64, as there are 64 of them and they have dimensions of 32×32. This set of feature maps is referred to as \textcircled{1} in FIG. 11. These feature maps \textcircled{1} may input to the shared logic or augmented binarized convolution module.

At block 1140, the feature maps \textcircled{1} from block 1130 are input to the binarized convolution unit of the augmented binarized convolution module and a first binarized convolution is performed with 8 different filters having dimensions 3×3. This binarized convolution results in 8 output feature maps (as there are 8 filters), each having dimensions 32×32.

At block 1150, the binarized convolution unit outputs the 8×32×32 feature maps resulting from the first binarized convolution. This set of feature maps is referred to as \textcircled{2} in FIG. 11.

At block 1160 the feature maps \textcircled{2} from the first binarized convolution are concatenated with the feature maps \textcircled{1} which were input to the augmented binarized convolution module. For example, the augmentation unit may perform an identity operation and forward the input feature maps \textcircled{1} to the concatenation unit. The concatenation unit then concatenates the feature maps \textcircled{1} with the feature maps \textcircled{2} output from the binarized convolution unit. The concatenated feature maps are referred to as \textcircled{3} in FIG. 11 and comprise 72 channels (feature maps) as this is the sum of the 64 feature maps \textcircled{1} from block 1130 and 8 feature maps \textcircled{2} from block 1150. The concatenated feature maps \textcircled{3} have dimensions 32×32 and so are expressed as 32×32×72 in FIG. 11. The concatenated feature maps \textcircled{3} are then output to the next processing stage. For example, the concatenated feature maps \textcircled{3} may be input back into the binarized convolution unit and augmentation unit of the augmented binarized convolution module.

At block 1170, a second binarized convolution is performed on the feature maps \textcircled{3} using 8 different filters of dimensions 3×3. These 8 filters may be the same as the filters used in block 1140. Thus the filters of the first binarized convolution operation may be re-used in the second binarized convolution operation. The second binarized convolution thus generates 8 output feature maps (as there are 8 filters) of dimensions 32×32.

At block 1180, the binarized convolution unit outputs the 8×32×32 feature maps resulting from the second binarized convolution. This set of feature maps is referred to as \textcircled{4} in FIG. 11.

At block 1190 the feature maps \textcircled{4} output from the second binarized convolution are concatenated with the feature maps \textcircled{3} which were input to the augmented binarized convolution module in block 1160. For example, the augmentation unit may perform an identity operation and forward the input feature maps \textcircled{3} to the concatenation unit and the concatenation unit may then concatenate the feature maps \textcircled{3} with the feature maps \textcircled{4}. The concatenated feature maps \textcircled{4},\textcircled{3} are referred to as feature maps \textcircled{5} in FIG. 11. There are 80 output feature maps \textcircled{5} (i.e. 80 channels) as this is the sum of the 72 feature maps \textcircled{3} and the 8 feature maps \textcircled{4}. The feature maps \textcircled{5} have dimensions 32×32 and so are expressed as 32×32×80 in FIG. 11.

Thus far two augmented binarized convolution operations have been described. The first augmented binarized convolution operation corresponds to blocks 1140 to 1160 and the second augmented binarized convolution operation corresponds to blocks 1170 to 1190. Further augmented binarized convolution operations may be performed in the same manner by the augmented binarized convolution module. In the example of FIG. 11 there are eight such augmented binarized convolution operations in total, with the third to eighth operations being represented by the dashed lines between block 1190 and block 1195.

Block 1195 shows the output at the end of the eight binarized convolution operations which is 32×32×128, i.e. 128 output feature maps (channels) each having dimensions 32×32. There are 128 output channels as there are 64 input channels which are carried forward by the concatenation and 8×8 =64 channels generated by the first to eighth binarized convolutions in blocks 1140, 1160 etc., giving a total of 64+64=128.

Each binarized convolution may use the same set of 8 filters as used in blocks 1140 and 1170. In this way memory resources are saved, as while 64 binarized convolutions are performed and 128 output channels generated, only 8 filters need be saved in memory as these filters are re-used in each re-iteration. In contrast, conventional convolution processing blocks for implementing a CNN convolution layer with 128 output channels would require memory space for 128 filters (one filter for each output channel).

Thus it will be understood that according to certain examples of the present disclosure, a binarized convolution unit may be configured to apply a sequence of n filters X times to produce X*n output channels. In this context n is the number of filters (e.g. 8 in the example of FIG. 11) and X is the number of times the sequence of filters is applied (e.g. 8 times in the example of FIG. 11). Re-using the same sequence of filters in this way may significantly reduce the memory required to implement a CNN.

Concatenating the output of the augmentation unit with the binarized convolution may further increase the number of output channels without significantly increasing the memory resources required. Further, as explained above, the augmentation unit and concatenation may help to avoid or reduce information loss which may otherwise occur in binarized CNNs.

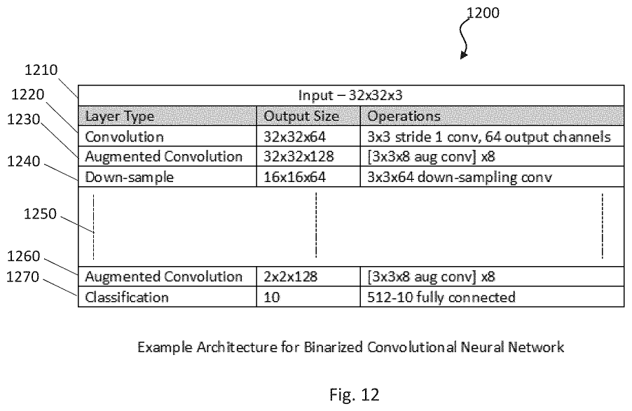

FIG. 12 shows an example architecture 1200 of a binarized CNN which may be implemented by a method, processor or logic chip according to the present disclosure. For example, the architecture of FIG. 12 may be implemented by any of the examples of the present disclosure described above with reference to FIGS. 1-11.

As shown in row 1210, of FIG. 12, the CNN receives an input of 32×32×3, i.e. 3 input channels of dimensions 32×32.

The subsequent rows correspond to layers of the CNN, with the first column indicating the layer type, the second column indicating output size of the layer and the third column indicating the operations carried out by the layer. The output of each layer forms the input of the next layer.

Thus row 1220 shows that the first layer of the CNN is a convolution layer which receives an input of 32×32×3 (the output of the previous layer) and outputs 32×32×64 (i.e. 64 output channels of dimensions 32×32). This layer may, for example, be implemented by a decoding module, such as the decoding module 310A shown in FIG. 3A. In some examples, the input 1210 to this first convolution layer may not be binarized, while the output of the first convolution layer 1220 may be binarized. For example the decoding module may apply a binarization function after the convolution in order to binarize the output feature maps. Row 1220 may be implemented by blocks 1110 to 1120 of FIG. 11 described above.

Rows 1230 to 1260 correspond to binarized convolution and down-sampling layers of the CNN and may be implemented by a shared logic module or an augmented binarized convolution module, such as those described in the examples above.

Row 1230 is an augmented convolution layer. It performs augmented convolution by combining (e.g. concatenating) the output of an augmentation operation with the output of a binarized convolution operation. It applies a sequence of 8 convolution filters having dimensions 3×3 to the input feature maps and concatenates the binarized convolutions with the outputs of the augmentation unit. This is repeated 8 times. The output of the augmented convolution layer is 32×32×128. Row 1230 of FIG. 12 may be implemented by blocks 1130 to 1195 of FIG. 11 described above.

Row 1240 is a down-sampling layer. The input of the down-sampling layer 1240 is the 32×32×128 output from the preceding augmented convolution layer 1230. In this example, the down-sampling layer applies 64 filters of dimensions 3×3 to the input in order to generate an output of 16×16×64. This operation is performed by the binarized convolution unit and referred to as a down-sampling convolution. It will be appreciated that, in this example, the dimensions of the output feature maps are half the dimensions of the input feature maps (reduced from 32×32 to 16×16). In this example the augmentation unit outputs a null output when implementing the down-sampling layer. As there is a null output from the augmentation unit, the output of this layer comprises the 64 channels output from the binarized convolution only. Thus, the number of output channels is halved compared to the number of input channels (64 output channels, compared to 128 input channels).

Thus far, one example binarized convolution layer and one example down-sampling layer have been described. Further binarized convolution layers and down-sampling layers may be included in the CNN architecture. The dashed lines denoted by reference numeral 1250 indicate the presence of such further layers which may be implemented according to the desired characteristics of the CNN.

Row 1260 corresponds to a final augmented convolution layer. At this point the input may have been reduced to dimensions of 2×2 through various down-sampling layers among the layers 1250. The augmented convolution layer 1260 applies 8 filters of 3×3 to perform binarized convolution on the input and repeats this sequence of filters 8 times. The output has a size of 2×2×128.

Row 1270 corresponds to a classification layer. The classification layer may, for example, be implemented by a fully connected layer module 360A as shown in FIG. 3A. The classification layer in this example comprises a fully connected neural network with 512 input nodes (corresponding to the 2×2×128 nodes output by the previous layer) and 10 output nodes. The 10 output nodes correspond to 10 possible classifications of the feature map 1210 input to the CNN. The number of possible classifications is equal to the number of output nodes of the classification layer. In other examples there may be more or fewer possible classifications and thus more or fewer output nodes of the fully connected neural network.

It will be appreciated that the method of FIG. 11 and the architecture of FIG. 12 are by way of example only. In other examples there could be different numbers of layers, different numbers, sizes and sequences of filters, different outputs from each layer and a different number of input nodes and output nodes for the classification layer.

It will further be appreciated that the output of a binarized convolution may not be binarized (e.g. as shown in FIG. 9), but may be binarized by a binarized activation (e.g. as shown in FIG. 8). Further, the binarized activation may be integrated into the binarized convolution unit. Meanwhile, while the output of an augmentation operation will generally be binarized. This is because in an identity operation there is no change to the feature map and in many other augmentation operations the locations of the values change to different cells, but the values themselves remain the same. However, if the augmentation operation is a scaling operation and the scaling factor is a non-zero value and is not equal to 1, then the output of the augmentation operation may not be binarized. In that case the output of the augmentation operation may be binarized by a binarized activation.

In the training phase where the filter weights (filter activations or filter values) are being adjusted, the activations are forward propagated in order to calculate the loss against training data and then back propagated to adjust the filter weights based on gradient descent. In some examples, the forward propagation may use binarized filter weights to calculate the loss against training data, while the backward propagation may initially back propagate the actual non-binarized gradients to adjust the original filter weights and then binarize the adjusted filter weights before performing the next iteration. In the inference phase the filter weights and the outputs of the binarized convolution and augmentation operations are binarized.

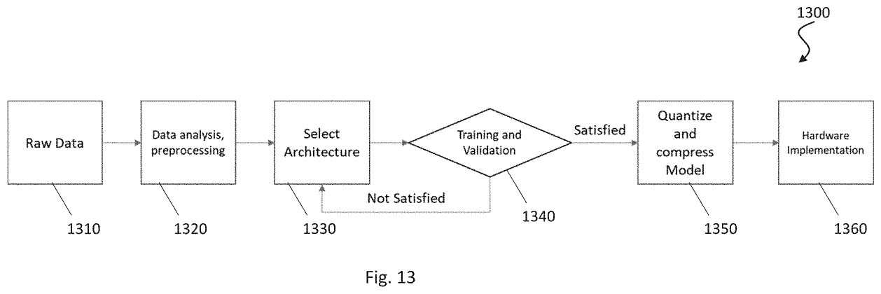

FIG. 13 shows an example method 1300 of designing a binarized CNN and a logic chip for implementing the binarized CNN according to the present disclosure.

At block 1310 raw data is obtained for use as training and validation data.

At block 1320 data analysis and pre-processing is performed to convert the raw data to data suitable for use as training and validation data. For example, certain data may be discarded and certain data may be filtered or refined.

At block 1330 an architecture for the CNN is designed. For example, the architecture may be an architecture comprising a plurality of convolution and down-sampling layers and details of the operations and outputs of those lays, for instance as shown in the example of FIG. 12.

At block 1340 a CNN having those layers is implemented and trained using the training data to set the activation weights of the filters and then validated using the validation data once the training is completed. The training and validation may be performed on a server of a computer using modules of machine readable instructions executable by a processor to implement the binarized CNN. That is a plurality of convolution layers and down-sampling layers may be simulated in software to perform the processing of the shared logic module or augmented binarized convolution module as described in the examples above.

If the results of the validation are not satisfactory at block 1340, then the architecture may be adjusted or re-designed by returning to block 1330. If the results are satisfactory, then this completes the training phase. In that case, the method proceeds to block 1350 where the model is quantized and compressed so that it can be implemented on hardware. For example the processing blocks may be rendered in a form suitable for implementation with hardware logic gates and the binarized activation and batch normalization may be integrated into the same processing block as the binarized convolution etc.

At block 1360 the CNN is implemented on hardware. For example, the CNN may be implemented as one or more logic chips such as FPGAs or ASICs. The logic chip then corresponds to the inference phase where the CNN is used in practice once the training has been completed and the activations and design of CNN have been set.

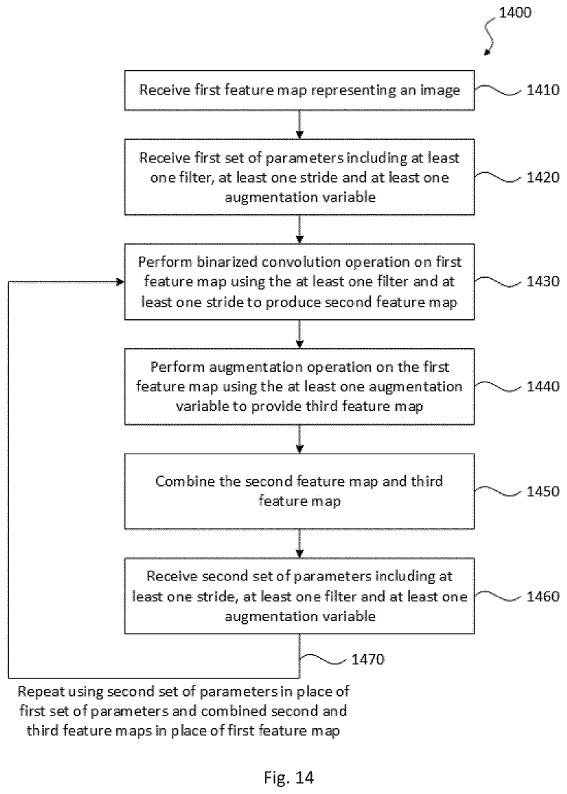

FIG. 14 shows a method 1400 of classifying a feature map by a processor. The feature map may for example be an image, an audiogram, a video, or other types of data. In some examples the image may have been captured by a camera of a device implementing the method. In other examples, the image may be data converted to image format for processing by the CNN.

At block 1410 the processor receives a first feature map which may correspond an image to be classified.

At block 1420, the processor, receives a first set of parameters including at least one filter, at least one stride and at least one augmentation variable.

At block 1430, the processor performs a binarized convolution operation on the input feature map using the at least one filter and at least one stride to produce a second feature map.

At block 1440, the processor performs an augmentation operation on the input feature map using the at least one augmentation variable to produce a third feature map.

At block 1450, the processor combines the second feature map and the third feature map.

At block 1460, the processor receives a second set of parameters including at least one filter, at least one stride and at least one augmentation variable.

At block 1470, blocks 1330 to 1360 are repeated using the second set of parameters in place of the first set of parameters and the combined second and third feature maps in place of the first feature map.

The first set of parameters have values selected for implementing a binarized convolutional layer of a binarized convolutional neural network and the second set of parameters have values selected for implementing a down-sampling layer of a binarized convolutional neural network. Further any of the features of the above examples may be integrated into the method described above.

The method may be implemented by any of the processors or logic chips described in the examples above. The method may be implemented on a general purpose computer or server or cloud computing service including a processor, or may be implemented on a dedicated hardware logic chip such as an ASIC or a FPGA etc. Where the method is implemented on a logic chip this may make it possible to implement CNN on resource constrained devices, such as smart phones, cameras, tablet computers or embedded devices such as logic chips for implementing a CNN which logic chips are embedded in a drone, electronic glasses, car or other vehicle, a watch or household device etc.

A device may include a physical sensor and a processor or logic chip for implementing a CNN as described in any of the above examples. For example, the logic chip may be a FPGA or ASIC and may include a shared logic module or augmented binarized convolution module as described in any of the examples above. The device may, for example, be a portable device such as, but not limited to, smart phone, tablet computer, camera, drone, watch, wearable device etc. The physical sensor may be configured to collect physical data and the processor or logic chip may be configured to classify the data according to the methods described above. The physical sensor may for example be a camera for generating image data and the processor or logic chip may be configured to convert the image data to a binarized feature map for classification by the CNN. In other examples, the physical sensor may collect other types of data such as audio data, which may be converted to a binarized feature map and classified by the CNN which is implemented by the processor or logic chip.

The above embodiments are described by way of example only. Many variations are possible without departing from the scope of the disclosure as defined in the appended claims.

For clarity of explanation, in some instances the present technology has been presented as including individual functional blocks including functional blocks comprising devices, device components, steps or routines in a method embodied in software, or combinations of hardware and software.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include read only memory, random access memory, magnetic or optical disks, flash memory, etc.

Devices implementing methods according to these disclosures can comprise hardware, firmware and/or software, and can take any of a variety of form factors. Typical examples of such form factors include laptops, smart phones, small form factor personal computers, personal digital assistants, logic chips and so on. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A processor for implementing a binarized convolutional neural network (BCNN) comprising a plurality of layers including a binarized convolutional layer and a down-sampling layer;
wherein the binarized convolution layer and the down-sampling layer are both executable by a shared logical module of the processor, the shared logical module comprising:
an augmentation unit to augment a feature map input to the shared logical module, based on an augmentation parameter;
a binarized convolution unit to perform a binarized convolution operation on the feature map input to the shared logical module, based on a convolution parameter; and
a combining unit to combine an output of the augmentation unit with an output of the binarized convolution unit;
wherein the shared logic module is switchable between a convolution mode and a down-sampling mode by adjusting at least one of the augmentation parameter and the convolution parameter.

2. The processor of claim 1 wherein the combining unit is to concatenate the output of the augmentation unit with the output of the binarized convolution unit.

3. The processor of claim 1 wherein the augmentation unit is to augment the feature map by performing at least one augmentation operation selected from the group comprising: an identity function, a scaling function, a mirror function, a flip function, a rotation function, a channel selection function and a cropping function.

4. The processor of claim 1 wherein the augmentation unit is to perform a scaling function on the feature map and the augmentation parameter is a scaling factor.

5. The processor of claim 4 wherein in the convolution mode the scaling factor is set as a non-zero value and in the down-sampling mode the scaling factor is set as a zero value.

6. The processor of claim 1 wherein the convolution parameter includes a filter and a stride.

7. The processor of claim 6 wherein in the down-sampling mode the stride is an integer equal to or greater than 2.

8. The processor of claim 1 wherein, in the convolution mode, the binarized convolution unit is to output a feature map having dimensions which are the same as dimensions of a feature map input to the binarized convolution unit.

9. The processor of claim 1 wherein, in the down-sampling mode, the binarized convolution unit is to output a feature map having dimensions which are smaller than dimensions of a feature map input to the binarized convolution unit.

10. The processor of claim 1 wherein, in the down-sampling mode, the shared logic module is to output a number of channels that is less than a number of channels that are input to the shared logic module.

11. A logic chip for implementing a binarized convolutional neural network (BCNN), the logic chip comprising:
a shared logic module that is capable of performing both a binarized convolution operation and a down-sampling operation on a feature map;
a memory storing adjustable parameters of the shared logic module, wherein the adjustable parameters determine whether the shared logic module performs a binarized convolution operation or a down-sampling operation; and
a controller or a control interface to control the shared logic module to perform at least one binarized convolution operation followed by at least one down-sampling operation by adjusting the adjustable parameters of the shared logic module.

12. The logic chip of claim 11 further comprising a decoding module for receiving a non-binarized input, converting the non-binarized input into a binarized feature map and outputting a binarized feature map to the shared logic module.

13. The logic chip of claim 11 wherein the shared logic module comprises:
a binarized convolution unit, a bypass unit and a concatenator;
wherein the shared logic module is to receive an input feature map;
the binarized convolutional unit is to perform a binarized convolution operation on the input feature map;
the by-pass unit is to forward the input feature map to the concatenator; and
the concatenator is to concatenate an output of the binarized convolution unit with an output of the by-pass unit.

14. The logic chip of claim 13, wherein the by-pass unit is to perform an augmentation operation on the input feature map before forwarding the input feature map to the concatenator.

15. The logic chip of claim 13, when the by-pass unit is to provide a null output to the concatenator when the shared logic module performs a down-sampling operation.

16. The logic chip of claim 13, wherein the by-pass unit is to perform a cropping or sampling operation to reduce a size of a feature map input to the by-pass unit before forwarding the feature map to the concatenator.

17. The logic chip of claim 13, wherein the binarized convolution unit is to perform a n×n binarized convolution operation, followed by a batch normalization and a binarized activation operation.

18. The logic chip of claim 13 wherein the binarized convolution unit is to apply a sequence of n filters X times to produce X*n output channels.

19. A method of classifying an image by a processor implementing a binarized convolution neural network, the method comprising:
a) receiving, by the processor, a first feature map corresponding to an image to be classified;
b) receiving, by the processor, a first set of parameters including at least one filter, at least one stride and at least one augmentation variable;
c) performing, by the processor, a binarized convolution operation on the input feature map using the at least one filter and at least one stride to produce a second feature map;
d) performing, by the processor, an augmentation operation on the input feature map using the at least one augmentation variable to produce a third feature map;
e) combining, by the processor, the second feature map and the third feature map;
f) receiving a second set of parameters including at least one filter, at least one stride and at least one augmentation variable;
g) repeating c) to e) using the second set of parameters in place of the first set of parameters and the combined second and third feature maps in place of the first feature map.

20. The method of claim 19 wherein the first set of parameters have values selected for implementing a binarized convolutional layer of a binarized convolutional neural network and the second set of parameters have values selected for implementing a down-sampling layer of a binarized convolutional neural network.
